(19) United States
(12) Patent Application Publication
(10) Pub. No.: US 2014/0289088 A1
(43) Pub. Date: Sep. 25, 2014

(54) LOAN SYSTEM, CREDIT INFORMATION GENERATING DEVICE, LOAN DETERMINING DEVICE AND LOAN CONDITION DETERMINING METHOD

(71) Applicant: YAHOO JAPAN CORPORATION, Tokyo (JP)

(72) Inventor: Yasuhisa TSUBATA, Tokyo (JP)

(73) Assignee: YAHOO JAPAN CORPORATION, Tokyo (JP)

(21) Appl. No.: 14/173,182

(22) Filed: Feb. 5, 2014

(30) Foreign Application Priority Data
Mar. 19, 2013 (JP) 2013-056481

(51) Int. Cl. G06Q 40/02

(52) U.S. Cl. CPC G06Q 40/025
USPC 705/37

(57) ABSTRACT

A loan system includes a loan determining device configured to determine a loan condition, and a credit information generating device configured to provide credit information of a store, which applies for a loan, to the loan determining device. The credit information generating device includes a storage unit that stores store operation result data including accumulation of latest data generated along with a store operation, a score data generating unit configured to generate score data of the store based on the store operation result data in a predetermined period, and a credit information generating unit configured to generate credit information of the store based on the score data. The loan determining device includes a credit information obtaining unit configured to obtain the credit information of the store, and a loan condition determining unit configured to determine a loan condition to the store based on the credit information of the store.

### CROSS-REFERENCE TO RELATED APPLICATIONS

The present application claims priority to and incorporates by reference the entire contents of Japanese Patent Application No. 2013-056481 filed in Japan on Mar. 19, 2013.

### BACKGROUND OF THE INVENTION

1. Field of the Invention

The present invention relates a loan system, a credit information generating device, a loan determining device and a loan condition determining method.

2. Description of the Related Art

A technology to calculate a credit limit for a business manager through information processing is known. For example, according to such a technology, an additional credit amount is calculated based on, an evaluation of accounts receivable and the result of business operation by the business manager (see, for example, Japanese Patent Application Laid-open No. 2007-172141). Further, according to another technology, an evaluation of a loan applicant by a third party is made public as debt information, and investors present a loanable amount using a bidding system (for example, see Japanese Patent Application Laid-open No. 2010-231268).

However, according to the above mentioned technologies, the evaluation of the accounts receivable and the evaluation of the business manager by the third party are performed based on an annual report of the business manager (for example, the financial statement or the income statement). In other words, the loan condition, i.e., the credit limit is calculated based on a “medium- to long-term” evaluation axes and evaluation criterion. Thus, the “short-term” loan condition is not accurately calculated.

For example, it is preferable that the loan condition for a business manager whose performance was unfavorable in the previous year's annual report however has rapidly been improving lately be calculated in consideration of, not only the performance of the previous year, but also the latest period.

In addition, to calculate the credit limit accurately, it is preferable that evaluations based on various criterion be considered; for example, it is preferable that the sales promotion, the newsiness of the business manager, and the marketing activity on the Web as well as the contents of the annual report (financial performance) be considered. However, evaluations of these aspects can change rapidly in a short term. Thus, it is difficult to use these evaluation axes in the calculation of loan condition.

### SUMMARY OF THE INVENTION

It is an object of the present invention to at least partially solve the problems in the conventional technology.

According to one aspect of an embodiment, a loan system includes a loan determining device configured to determine a loan condition and a credit information generating device configured to provide credit information of a store, which applies for a loan, to the loan determining device. The credit information generating device includes: a storage unit that stores store operation result data including accumulation of latest data generated along with a store operation; a score data generating unit configured to generate score data of the store based on the store operation result data in a predetermined period; and a credit information generating unit configured to generate credit information of the store based on the score data. The loan determining device includes: a credit information obtaining unit configured to obtain the credit information of the store; and a loan condition determining unit configured to determine a loan condition to the store based on the credit information of the store.

According to another aspect of an embodiment, a loan condition determining method in a loan system including a loan determining device configured to determine a loan condition, and a credit information generating device configured to provide credit information of a store, which applies for a loan, to the loan determining device, the loan condition determining method includes: storing, by the credit information generating device, store operation result data including accumulation of latest data generated along with a store operation; generating, by the credit information generating device, score data of the store based on the store operation result data in a predetermined period; and generating, by the credit information generating device, credit information of the store based on the score data, and obtaining, by the loan determining device, the credit information of the store; and determining, by the loan determining device, a loan condition to the store based on the credit information of the store.

According to still another aspect of an embodiment, a computer-readable recording medium has stored therein a loan condition determining program executed by a computer for a loan system including a loan determining device configured to determine a loan condition, and a credit information generating device configured to provide credit information of a store, which applies for a loan, to the loan determining device. The program causes a computer to execute a process including: storing store operation result data including accumulation of latest data generated along with a store operation; generating score data of the store based on the store operation result data in a predetermined period; generating credit information of the store based on the score data; obtaining the credit information of the store; and determining a loan condition to the store based on the credit information of the store.

According to still another aspect of an embodiment, a credit information generating device is configured to provide credit information of a store, which applies for a loan, to a loan determining device configured to determine a loan condition. The credit information generating device includes: a storage unit that stores store operation result data including accumulation of latest data generated along with a store operation; a score data generating unit configured to generate score data of the store based on the store operation result data in a predetermined period; and a credit information generating unit configured to generate credit information of the store based on the score data.

According to still another aspect of an embodiment, a loan determining device is configured to determine a loan condition for a store, which applies for a loan. The loan determining device includes: a credit information obtaining unit configured to obtain credit information of the store generated by a credit information generating device based on store operation result data in a predetermined period; and a loan condition determining unit configured to determine a loan condition to the store based on the credit information.

According to still another aspect of an embodiment, a computer-readable recording medium has stored therein a credit information generating program. The program causes a computer to function as: a storage unit that stores store operation result data including accumulation of latest data generated along with a store operation; a score data generating unit configured to generate score data of the store based on the store operation result data in a predetermined period; and a credit information generating unit configured to generate credit information of the store based on the score data.

According to still another aspect of an embodiment, a computer-readable recording medium has stored therein a loan condition determining program. The program causes a computer to function as: a credit information obtaining unit configured to obtain credit information of the store generated by a credit information generating device and based on store operation result data in a predetermined period; and a loan condition determining unit configured to determine a loan condition to the store based on the credit information.

The above and other objects, features, advantages and technical and industrial significance of this invention will be better understood by reading the following detailed description of presently preferred embodiments of the when considered in connection with the accompanying drawings.

### BRIEF DESCRIPTION OF THE DRAWINGS

FIG. 1 is an overall view for describing how a loan is made according to an embodiment;

FIG. 2 is a diagram of an exemplary functional configuration of an embodiment;

FIG. 3 is a diagram of an exemplary hardware configuration of a credit information generating server according to an embodiment;

FIG. 4 is a diagram of an example of basic store data;

FIG. 5 is a diagram of an example of reservation result data;

FIG. 6 is a diagram of an example of coupon result data;

FIG. 7 is a diagram of an example of sales result data;

FIG. 8 is a diagram of an example of customer history data;

FIG. 9 is a diagram of an example of Web management data;

FIG. 10 is a diagram of an example of score data;

FIG. 11 is a diagram of an example of credit information;

FIG. 12 is a flowchart of a process for generating score data;

FIG. 13 is a flowchart of a process for generating credit information;

FIG. 14 is a flowchart of a process for determining a loan condition;

FIG. 15 is a diagram of an exemplary loan condition display screen;

FIG. 16 is a diagram of another exemplary loan condition display screen;

FIG. 17 is a diagram of still another exemplary loan condition display screen; and

FIG. 18 is a diagram of still another exemplary loan condition display screen.

### DETAILED DESCRIPTION OF THE PREFERRED EMBODIMENTS

Hereinafter, an embodiment of the present invention will be described.

### Configuration Framework of Loan

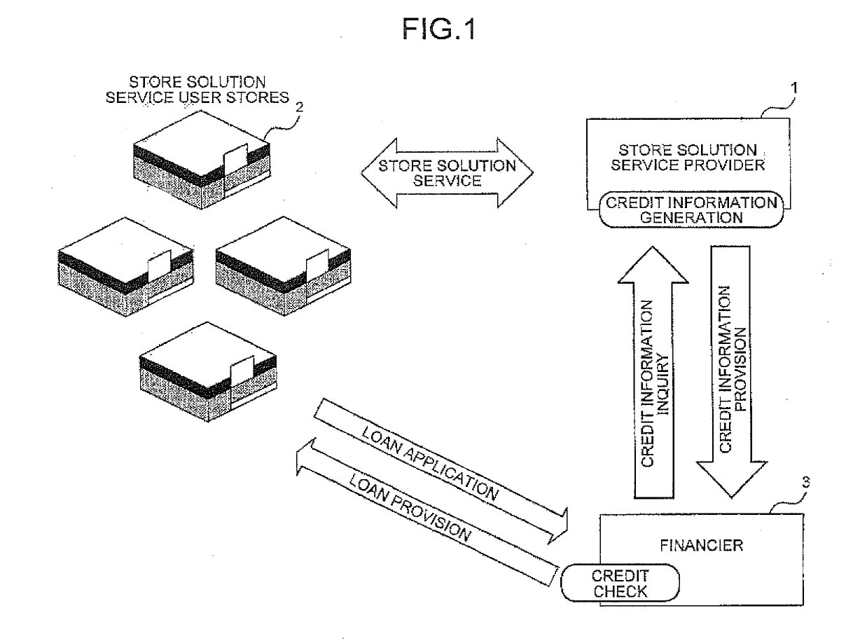

FIG. 1 is an overall view for describing how a loan is made according to the present embodiment. As illustrated in FIG. 1, there are a store solution service provider 1, store solution service user store(s) 2, and a financier 3 in the present embodiment.

The store solution service provider 1 (hereinafter, merely referred to as a provider 1) provides various systems related to the store operation to the store solution service user stores 2 as the store solution service.

The “store solution service” is a service provided by an external enterprise to a store which outsources a system related to an operation of the store which otherwise the store needs to prepare on its own. In other words, the “store solution service” is a system related to a management of a store provided via a network, such as a system provided by an application service provider (ASP), i.e, an ASP-type system. The “store solution service” may include, for example, an ASP-type reservation system, a customer relationship management (CRM) tool, a point of sale (POS) system, and a sales management system. As a result of the prevalence of the Internet, the “store solution service” may also include a service related to the Internet such as a creation and management of a Website and online advertising.

The store solution service user store 2 (hereinafter, merely referred to as a store 2) is a business entity which has a store and performs a commercial activity by using various types of store solution services provided by the provider 1. The store solution service can be provided, for example, through a Web browser or dedicated application on a store terminal (for example, a PC) of the store 2. The store 2 can use various store solution services by accessing, for example, a store solution service providing server of the provider 1 from a Web browser or the like on the store terminal and logging in as a user.

Note that the store can also be a virtual store (a store on the Internet) because a store with any commercial activity can use at least one of the store solution services even without a physical entity. However, for the convenience of description, the store 2 is assumed to be a real store, e.g., a restaurant or a shop.

The financier 3 lends money, e.g., provides a business loan to the entity that runs the store 2, e.g., a business manager. When receiving a request (application) for a loan from the manager of the store 2, the financier 3, by a loan determining terminal, inquires the provider 1 for the credit information of the store 2 that has requested the loan. The financier 3 receives the credit information from the provider 1, performs a credit check by the loan determining terminal, determines the loan condition (credit limit), and provides a loan actually based on the determined loan condition. Note that the loan condition herein includes, for example, the loan amount, the lending period, and the loan interest.

### Store Solution Service

As described above, the store solution service is a system relating to the store operation that the provider 1 provides to the store 2. The store solution service includes, for example, a reservation system, a CRM tool, a POS system, and a sales management system. The store solution service also includes an Internet service such as a creation and management of a Website, and online advertising.

The reservation system is configured to receive reservations from customers on the Internet and to manage the status of reservations. When the store receives a reservation on the telephone or the like, the store can access the reservation system to input the details of reservation and thus manage the reservations integrally. The reservation system manages various types of data related to reservation, such as, the current reservations, the past reservations, and the cancellations. Thus, various types of analysis data of the reservation can be provided to the store 2 in the form of a table, statistics or the like based on the reservation data.

The CRM tool performs customer management, for example, the CRM tool manages a customer list, a membership list, or a buying history. Recent CRM further manages coupons, e.g., the issuance and recovery of the coupons (including the analysis of the effect of the coupons). The CRM tool manages various types of data related to customer management, such as, the store visit data and purchase histories of the customers. Thus, various types of analysis data of the customer can be provided to the store 2 based on the customer management data; for example, analysis on segmentation of customers and customer retention rate. In particular, with regard to coupon management, an effect of the coupon can be analyzed based on the relationship between the number of recovered coupons, and the issuance time, the number of issued coupons, or the type of coupons.

The point of sale (POS) system records and adds the information about each sale of the product, food and drink at the store. The result is used for the sales management, the stock management, or the purchase management.

The POS system manages various types of sales management data including the information about the sale of types of analysis data related to sales management can be provided to the store based on the sales management data; for example, analysis data, on popular items can be provided.

The sales management system manages the sales and the accounts receivable while cooperating with other system such as the POS system and a checkout system. The sales management system is also capable of providing analysis data on the sales, such as data on breakdown of the payment (for example, by cash or by card), the breakdown of the sales (for example, sales of food and drink or sales of products).

The Internet service sets up a store website using a rental server and provides Web management data including the traffic to the website, the number of searches, the search word, the number of word-of-mouth column contributions, and the contents of the word-of-mouth. The Internet service can deliver an Internet advertisement to an advertising medium and analyze the effect of the delivered advertisement.

### System Configuration

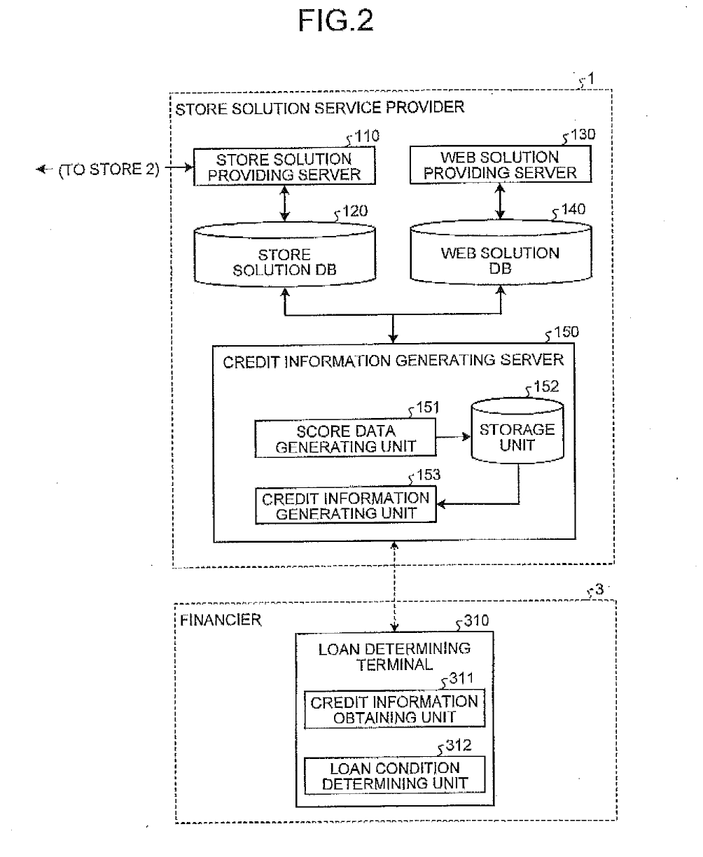

FIG. 2 is a diagram of an exemplary functional configuration according to the embodiment. The provider 1 includes a store solution providing server 110, a store solution database (DB) 120, a Web solution providing server 130, a Web solution DB 140, and a credit information generating server 150. The financier 3 includes a loan determining terminal 310.

The store solution providing server 110 provides a store solution service to the store 2. At that time, the store solution providing server 110 stores various types of information used for various store solution services in the store solution DB 120.

For example, when the store solution provider 1 provides the reservation system to the store 2 which is a restaurant, the store solution DB 120 manages and stores reservation data for each store ID (Identifier). The reservation data may include reservation time and date, number of people, and content of the course. Alternatively, when the store solution provider 1 provides the CRM tool to the store 2 which is a retail shop, the store solution DB 120 manages, stores, and accumulates the customer data for each store ID. The customer data may include a customer list (membership list), and buying history.

The Web solution providing server 130 provides a Web solution service to the store 2. For providing the Web solution service, the Web solution providing server 130 stores various types of information used for various Web solution services in the Web solution DB 140.

For example, when the store solution provider 1 provides a store website to the store 2, the Web solution DE 140 manages, stores, and accumulates the Web management data for each store ID. The Web management data may include traffic to the website, search number, search word, number of word-of-mouth column contributions, and contents of word-of-mouth.

The credit information generating server 150 includes a score data, generating unit 151, a storage unit 152, and a credit information generating unit 153.

The score data generating unit 151 obtains log data (store operation result data) stored and accumulated in the store solution DB 120, and log data (the Web management data of the store) stored and accumulated in the Web solution DB 140 and generates score data of each store using the obtained log data. The score data is the source of credit information used for scoring and determining the loan condition. The score data generating unit 151 generates score data and generates the supplemental information with which the score data is supplemented using the obtained log data.

Note that the supplemental information with which the score data is supplemented is in particular the store operation result data stored and accumulated in the store solution DB 120 and the Web management data stored and accumulated in the Web-solution DB 140. In other words, the supplemental information is the RAW data (original data) of the store operation result data and Web management data that is used when the score data generating unit 151 generates the score data. The supplemental information is used on the loan determining terminal 310 side again to regenerate the score data.

The score data generating unit 151 accesses the store solution DB 120 and the Web solution DB 140 to periodically obtain the log data and generate the score data and supplemental information for each store, and then stores the generated score data and supplemental information of each store in the storage unit 152.

The credit information generating unit 153 obtains the generated score data and supplemental information of the store 2 from the storage unit 152 after the credit information generating server 150 receives the inquiry for the credit information of the store 2 from the loan determining terminal 310 of the financier 3. Then, the credit information generating unit 153 generates the credit information to finally be provided to the financier 3 based on the obtained score data.

Once the credit information is generated, the credit information generating server 150 transmits, to the loan determining terminal 310, the credit information generated by the credit information generating unit 153 by adding the supplemental information obtained from the storage unit 152 to the credit information.

The loan determining terminal 310 includes a credit information obtaining unit 311 and a loan condition determining unit 312.

The credit information obtaining unit 311 obtains the credit information of the stare 2 that has requested a loan by inquiring for the credit information of the store 2 to the credit information generating server 150. The credit information obtaining unit 311 also obtains the supplemental information.

The loan condition determining unit 312 determines the loan condition (the loan amount, the loan period, the loan interests, and the like) for the store 2 based on the credit information of the store 2. The financier 3 can actually provides the loan to the store 2 according to the determined loan condition.

Note that function units included in the credit information generating server 150 may be implemented by computer programs executed on hardware resources such as a CPU (Central Processing Unit), ROM (Read Only Memory), and RAM (Random Access Memory) on a computer included in the device. However, the function units can also be referred to as “means”, “modules”, “units”, or “circuits”.

The function units included in the credit information generating server 150 may not be incorporated into a single computer. The function units may be distributed on more than one computer.

For example, the store solution DB 120 and the Web solution DB 140 may be integrated with the store solution providing server 110 and the Web solution providing server 130. The store solution providing server 110 and the Web solution providing server 130 may be integrated as a single serve

### Hardware Configuration

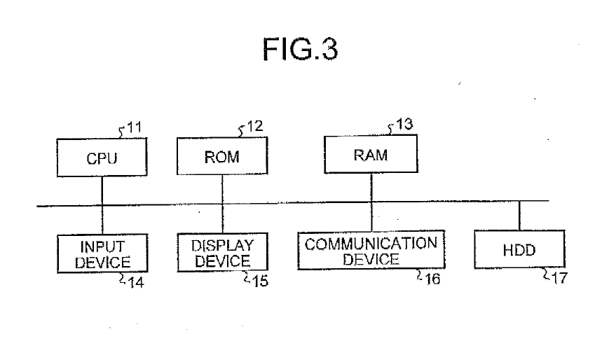

FIG. 3 is a diagram of an exemplary hardware configuration of the credit information generating server 150 according to the present embodiment. The credit information generating server 150 includes a central processing unit (CPU) 11, a read only memory (ROM) 12, a random access memory (RAM) 13, an input device 14, a display device 15, a communication device 16, and an HDD 17 as a main configuration.

The CPU 11 includes a microprocessor and a peripheral circuit and is a circuit configured to control the credit information generating server 150. The ROM 12 is a memory configured to store a predetermined control program (software componentry) executed in the CPU 11. The RAM 13 is a memory used as a work area (word region) for various kinds of control while the CPU 11 executes the predetermined control program (software componentry) stored in the ROM 12.

The input device 14 is for various input operations by a user (administrator). The input device 14 includes a mouse, and a keyboard. The display device 15 is configured to display a display screen and includes, for example, a liquid crystal display (LCD) or a cathode ray tube (CRT).

The communication device 16 is configured to communicate with another device through a network. The communication device 16 supports communications in various forms of network including a wired network and a wireless network.

The HDD 17 is a device configured to store a general-purpose operating system (Os), various OBs relating to advertisement, and a program according to the present embodiment. For example, a hard disk drive (HDC) that is a non-volatile storage device is used as the HDD 17. Note that the various types of information can be stored not only in the HDD 17 but also in a storage medium such as a compact disk-ROM (CD-ROM) or a digital versatile disk (DVD), or in another medium. The various types of information stored in such a storage medium can be read through a drive device, for example, a storage medium read device. Thus, setting a recording medium on the storage medium read device provides various types of information as necessary.

Note that the loan determining terminal 310 may include an information processing apparatus such as a personal computer (PC), a smartphone, a mobile phone, a tablet terminal, or a personal digital assistant (PDA). A particular diagram of the loan determining terminal 310 is omitted (not illustrated in the drawings).

### Store Solution DB 120

As described above, the store solution providing server 110 provides a store solution service to the store 2. Thus, the store solution providing server 110 stores various types of information used for various store solution services in the store solution DB 120. Hereinafter, basic store data, reservation result data, coupon result data, sales result data, and customer history data are described as examples of the information stored in the store solution DB 120.

### Basic Store Data

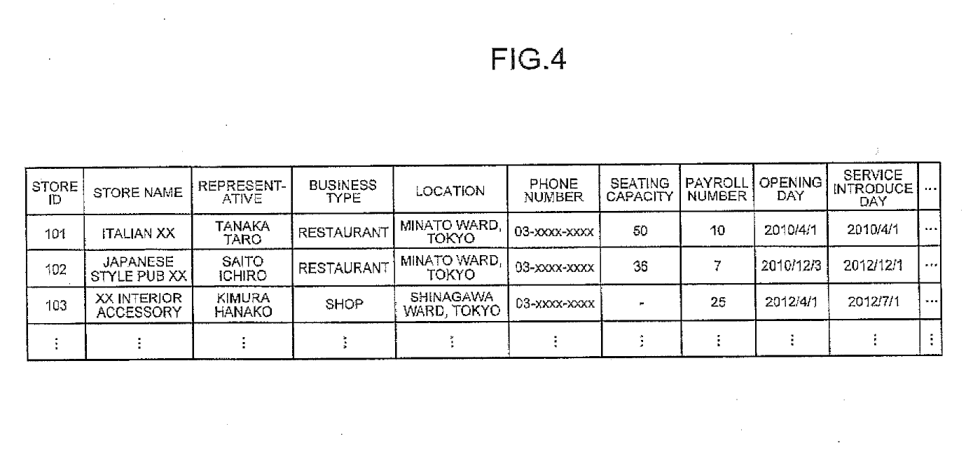

FIG. 4 is a diagram of an example of the basic store data according to the present embodiment. The basic store data is data of the store 2 to which the store solution service is provided. Specifically, the basic store data may include data items such as “store ID”, “store name”, “representative”, “business type”, “location”, “phone number”, “seating capacity”, “payroll number”, “opening day” and “service introduction day”.

The information is registered based on, for example, information reported by the store 2 at the subscription to the store solution service. Note that when a store is registered, “store ID” that is a unique identifier identifying the store is issued and granted to each store.

### Reservation Result Data

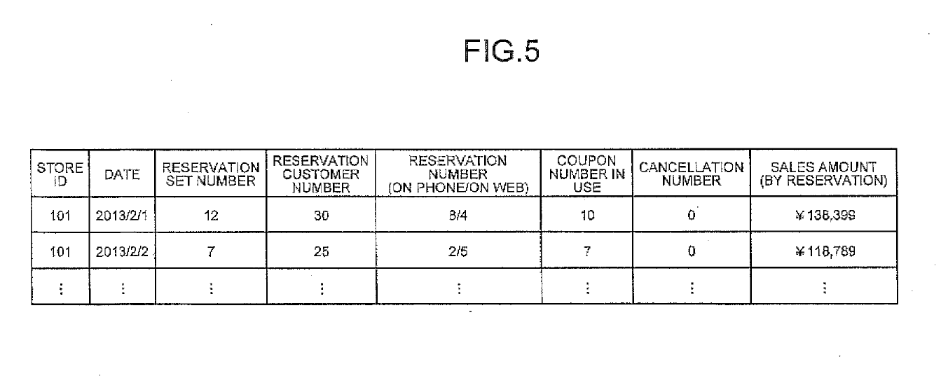

FIG. 5 is a diagram of an example of the reservation result data according to the present embodiment. The reservation result data is used and is accumulated by the reservation system that is a store solution service. The reservation result data is accumulated for each store, for example, on a daily basis.

In particular, the reservation result data may include data items such as “store ID”, “date”, “number of sets of reservation”, “number of reservation customers”, “reservation number (on the phone/on the Web)”, “number of coupons in use”, “cancellation number”, and “sales amount (by reservation)”.

The “store ID” corresponds to the “store ID” in the basic store data and is an identifier identifying a store.

The “date” indicates the date of the reservation result data.

The “number of sets of reservation” indicates the number of sets of customers who have made a reservation.

The “number of reservation customers” indicates the number of the customers who have made a reservation.

The “reservation number (on the phone/on the Web)” indicates the number of reservations that the customers have made, and includes the breakdown of the reservation methods, i.e., whether the reservation is made on the phone or via the web. Note that it can be determined that the store has a larger future potential when the “reservation number” is larger, or when the store secures a predetermined number of reservations every day.

The “number of coupons in use” indicates the number of customers or sets of customers who use the coupon. Note that it can be determined that the larger the “number of coupons in use” is, the larger the effect of the coupons is.

The “cancellation number” indicates the number of cancellations among the “reservation number” that the customers have made. Note that it can be determined that the smaller the “cancellation number” is, the larger the future potential of the store is.

The “sales amount (by reservation)” indicates the sales amount generated from the reservations.

### Coupon Result Data

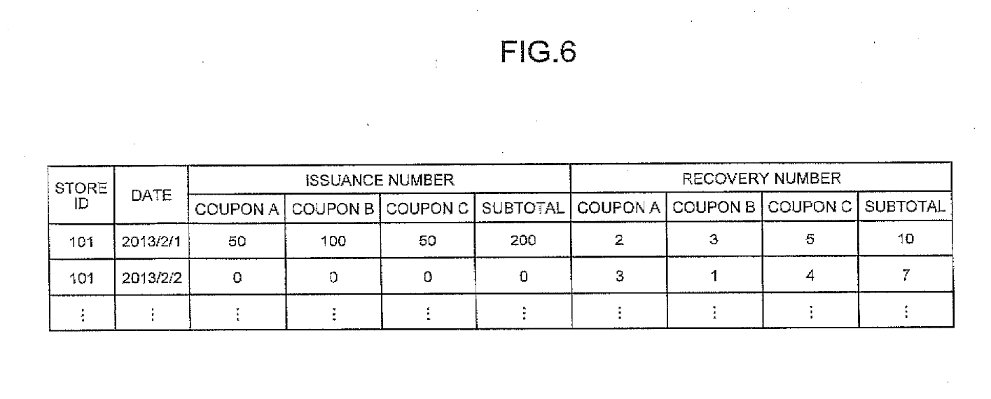

FIG. 6 is a diagram of an example of the coupon result data according to the present embodiment. The coupon result data is used and is accumulated by the CRM tool that is a store solution service. The coupon result data is accumulated for each store, for example, on a daily basis.

In particular, the coupon result data may include data items such as “store ID”, “date”, “issuance number”, and “recovery number”.

The “store ID” corresponds to the “store ID” in the basic store data and is an identifier identifying a store.

The “date” indicates the date of the coupon result data.

The “issuance number” indicates the number of issued coupons. The issuance number is counted and managed for each type of coupons. Note that it can be determined that the larger the “issuance number” is, the more positively the store sales promotion is conducted, and thus the larger the future potential of the store is.

The “recovery number” indicates the number of recovered coupons. The recovery number is counted and managed for each type of coupons. Note that it can be determined that the larger the “recovery number” is, or the higher the recovery rate (=the “recovery number”/the “issuance number”) is, the larger the effect of the coupons is.

### Sales Result Data

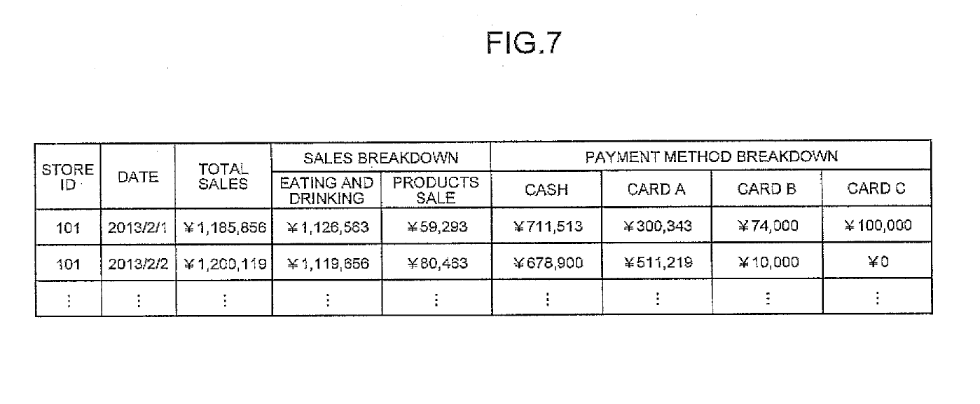

FIG. 7 is a diagram of an example of the sales result data according to the present embodiment. The sales result data is used and is accumulated by the POS system and the sales management system that are store solution services. The sales result data is accumulated for each store, for example, on a daily basis.

In particular, the sales result data may include data items including a “store ID”, a “date”, a “total sales”, a “sales breakdown” and a “payment method breakdown”.

The “store ID” corresponds to the “store ID” in the basic store data and is an identifier identifying a store.

The “date” indicates the date of the sales result data.

The “total sales” indicates all of the sales, namely, the amount of the total sales.

The “sales breakdown” indicates the amount of sales of each item in the breakdown of the “total sales”. For example, when the store is a restaurant, the breakdown includes the sales of the “eating and drinking” provided in the stone and the sales of the “products sale” such as souvenirs.

The “payment method breakdown” indicates the amount of payment by each payment method in the breakdown of the “total sales”. For example, when the store is a restaurant, customer can pay by cash or a card at the checkout. Further, the card payment may be further divided into payment methods by a credit card A, by a credit card B, and by an electronic money card C.

### Customer History Data

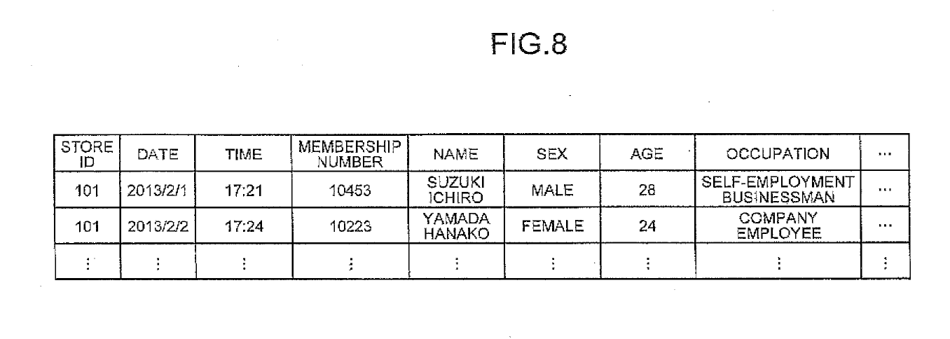

FIG. 8 is a diagram of an example of the customer history data according to the present embodiment. The customer history data (the data of visits) is used and is accumulated by the CRM tool that is a store solution service. The customer history data is accumulated for each store, for example, on a customer basis.

In particular, the customer history data may include data items such as “store ID”, “date”, “time”, “membership number”, “name”, “sex”, “age”, and “occupation”.

The “store ID” corresponds to the “store ID” in the basic store data and is an identifier identifying a store.

The “date” indicates the date on which the customer visited the store, on which the customer used the facility, or on which the customer purchased the product.

The “time” indicates the time on which the customer visited the store, on which the customer used the facility, or on which the customer purchased the product.

The “membership number” is an identifier identifying the customer. The customer is managed using a unique membership number at each store.

The “name”, “sex”, “age”, and “occupation” are the customer information (customer attributes).

The customer information is registered based on, for example, the information reported by the customer at the membership registration to the store. Note that the customer history data including the customer information can be used for the analysis of the customer classification. It is determined, for example, based on the number of histories whether the customer retention rate is high.

### Web Solution DB 140

As described above, the Web solution providing server 130 provides the Web solution service to the store 2. Thus, the Web solution providing server 130 stores various types of information used for various store solution services in the Web solution DB 140. Hereinafter, the Web management data is described as an example of information stored in the Web solution DB 140.

### Web Management Data

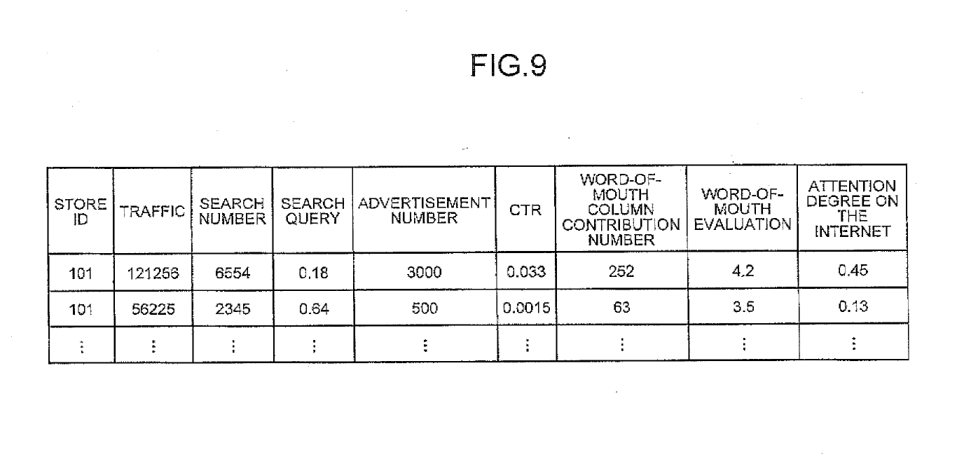

FIG. 9 is a diagram of an example of the data of the Web management according to the present embodiment. The Web management data is used and is accumulated by an Internet service that is a store solution service. The Web management data is accumulated for each store ID, for example, as an accumulated value or on a predetermined interval basis.

In particular, the Web management data includes data items such as “store ID”, “traffic”, “search number”, “search query”, “advertisement number”, “CTR”, “word-of-mouth column contribution number”, “word-of-mouth evaluation” and “attention degree on the Internet”.

The “store ID” corresponds to the “store ID” in the basic store data and is an identifier identifying a store.

The “traffic” is the number of visitors or, namely, the amount of traffic to the store Website. The traffic is counted with an access counter or the like. It can be determined that the larger the “traffic” is, or when a predetermined amount of “traffic” is secured everyday, the higher the evaluation of the store on the Internet is.

Note that the amount of accesses by a unique user can be counted as the “traffic”. The unique user is an individual visitor among the visitors to the store website in a specified period. Thus, the amount of access of the unique user is not the total number of visits. A visitor who has visited several times is counted as a visitor. By counting the number of unique users allows to more accurately determine how many people are interested in the store in comparison with when the traffic is simply counted. The unique user can be discriminated using the user ID, for example, when the individual user ID can be specified from the access. Alternatively, the unique user can be discriminated using the Cookie information through the browser when the user ID is not specified. Alternatively, the unique user can be discriminated using the unique ID of a terminal device (for example, a MAC address) when the access is from the terminal device through the wireless WAN/LAN.

The “search number” indicates the number of searches of the store (store website) from a search engine or the like. For example, the “search number” is counted up when the words relating to the store name or the store are used as the search words. It can be determined that the larger the “search number” is, or when a predetermined “search number” is secured everyday, the higher the evaluation to the store on the Internet is.

The “search query” is the evaluation value calculated based on the search query (search words) when the store (store website) is searched from a search engine or the like. When a store is searched with a plurality of search queries such as the store name and another query, for example, the “store name” and a “XX”, the search queries are weighted heavier than when a search is conducted with a single search query. When the queries include positive contents to the evaluations of the store, for example, the “reservation”, the “location”, the “directions”, the “route”, and the “menu”, the queries can be weighted even heavier. It can be determined that the higher the “search query” is, the higher the evaluation of the store is.

The “advertisement number” indicates the number of the advertisements that the store website has placed, for example, on the Internet. The larger the “advertisement number” is, the more times the store is exposed. Thus, it can be determined that the store is highly evaluated on the Internet.

The “CTR” is an index for measuring the effect of advertisement and, for example, indicates the click rate on a banner advertisement, i.e., Click Through Rate. The higher the value of the “CTR” is, the higher the advertisement effect is. It can be determined that the higher the value of the “CTR” is, the higher the advertisement effect is, and thus the store is highly evaluated on the Internet.

The “word-of-mouth column contribution number” indicates the number of contributed word-of-mouth columns relating to the store. The word-of-mouth column is, for example, the evaluation (evaluation value), feedback, or comment that written into a website for word-of-mouth. It can be determined that the larger the “word-of-mouth column contribution number” is, the higher at least the degree of interest or attention to the store by the public is.

The “word-of-mouth evaluation” is the total value (for example, average value) of the evaluations (evaluation values) to the store written, for example, in the website for word-of-mouth. It can be determined that the higher the “word-of-mouth evaluation” is, the more highly the store is evaluated.

The “attention degree on the Internet” indicates the degree of attention to the store on the website. The “attention degree on the Internet” is counted based, on, for example, the contents, amount, or frequency of the topic about the store featured on a bulletin board, the news, an article, the contents on another Website, or the like. It can be determined that the higher the “attention degree on the Internet” is, the higher the degree of interest or attention to the store is and thus the more highly the store is evaluated.

### Score Data

As described above, the score data generating unit 151 in the credit information generating server 150 obtains the log data (store operation result data) stored and accumulated in the store solution DB 120 and the log data (Web management data of the store) stored and accumulated in the Web solution DB 140 to generate the score data for each store using the obtained log data.

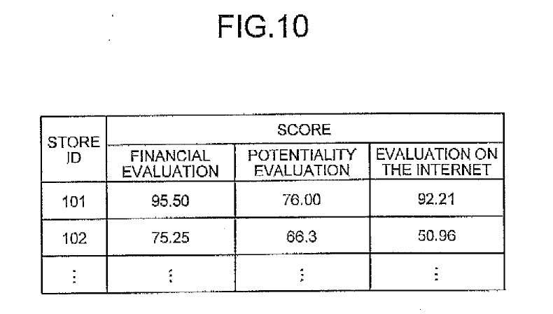

FIG. 10 is a diagram of an example of score data according to the present embodiment. The score data is the source of the credit information used for determining the loan condition (loan amount, loan period, lean interest and the like) for each store 2 to which the store solution service is provided. Thus, the score is a score value of the evaluation axes (evaluation criterion) for the evaluation of the credit limit. Specifically, the score data includes the evaluation axis (evaluation criteria) such as “financial evaluation”, “potentiality evaluation”, and “evaluation on the Internet”, and the score values corresponding to each evaluation axis.

The “financial evaluation” is the evaluation value of the financial soundness of the store 2. The financial soundness is evaluated and calculated from various points, for example, the cash flow, the accounts receivable, and the debt (for example, the loan from the financier or the like, or the accounts payable that have not been paid). The higher the evaluations are, the higher the score values are. Note that the score value of the “financial evaluation” is calculated mainly based on the log data (store operation result data) stored and accumulated in the store solution DB 120 and using a predetermined evaluation algorithm (for example, a predetermined evaluation function A). As the latest log data (store operation result data) stored and accumulated in the store solution DB 120 is used, the calculated evaluation value can reflect the latest financial state.

The “potentiality evaluation” is the evaluation value of the potential of the store 2. The score value is calculated by the evaluation of the potential (also referred to as the possibility of development) of the store in views other than the financial view, for example, the number of issued or recovered coupons, the number of reservations, the trends in the number of reservations, and the customer retention rate. The higher the evaluations are, the higher the score values are. Note that the score value of the “potentiality evaluation” is calculated mainly based on the log data (store operation result data) stored and accumulated in the store solution DB 120 and using a predetermined evaluation algorithm (for example, a predetermined evaluation function B).

The “evaluation on the Internet” is the evaluation value of the topicality of the store 2. The score value is calculated when the store is raised as a topic or gets noticed on the Internet in views of, for example, the traffic to the store Website, the number of searches, the search queries, the number of advertisements, the CTR, the number of word-of-mouth columns, the word-of-mouth evaluation, and the attention degree. The higher the evaluations are, the higher the score values are. Note that the score value of the “evaluation on the Internet” is calculated mainly based on the log data (Web management data of the store) stored and accumulated in the Web solution DB 140 and using a predetermined evaluation algorithm (for example, a predetermined evaluation function C).

Note that the evaluation axis (evaluation criteria) such as the “financial evaluation”, the “potentiality evaluation”, and the “evaluation on the Internet” are merely examples. In addition to the evaluations as described above, the score data can include other evaluation axes (evaluation criterion) for the evaluation of the loan condition.

### Credit Information

As described above, when receiving an inquiry for the credit information of the store 2 from the loan determining terminal 310 of the financier 3, the credit information generating server 150 obtains the generated score data of the store 2 from the storage unit 152. Then, the credit information generating unit 153 generates the credit information to eventually be provided to the financier 3 based on the obtained score data.

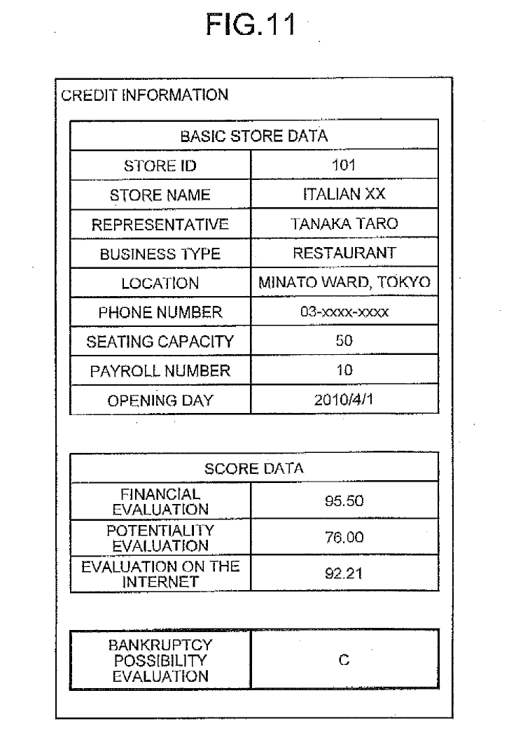

FIG. 11 is a diagram of an example of credit information according to the present embodiment. The credit information is used for determining the loan conditions to the store 2 to which the store solution service is provided. Specifically, the credit information may include data items such as “basic store data”, “score data”, and “bankruptcy possibility evaluation”.

The “basic store data” is the basic date of a store. For example, the “basic store data” can be input to the credit information after being obtained from the basic store data in the store solution DB 120 (for example, FIG. 4) using the “store ID” as a key.

The “score data” is the generated score data of the store 2 obtained from the storage unit 152 (FIG. 10). The “score data” may include, for example, the “financial evaluation”, the “potentiality evaluation”, and the “evaluation on the Internet”.

The “bankruptcy possibility evaluation” is the evaluation value evaluating the possibility of bankruptcy of the store. The evaluation includes the evaluation values, for example, A to E. The E indicates that the possibility of bankruptcy is the lowest. In other words, the store is highly evaluated. The “bankruptcy possibility evaluation” is calculated based on the “score data” and using a predetermined evaluation algorithm (for example, a predetermined evaluation function D).

Note that the data items such as the “basic store data”, the “score data”, and the “bankruptcy possibility evaluation” are merely examples. In addition to these data items, the credit information may include other data items for the evaluation of the loan condition.

The credit information generating server 150 transmits the credit information together with the supplemental information obtained from the storage unit 152 to the loan determining terminal 310.

### Information Process in Credit Information Generating Server 150 Score Data Generating Process

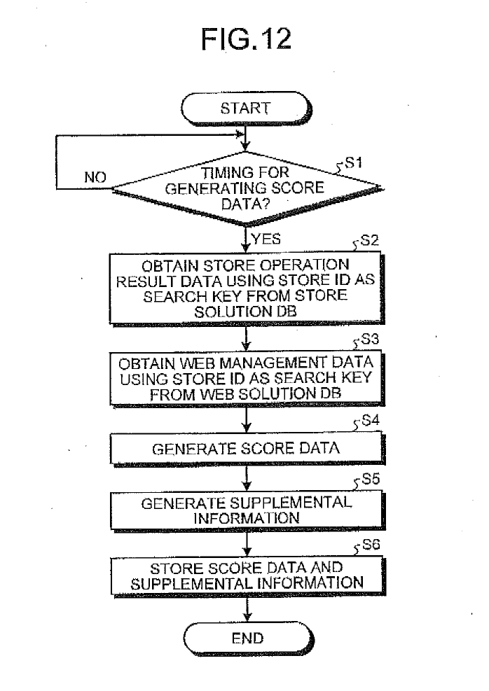

FIG. 12 is a flowchart of a process for generating score data in the credit information generating server 150 according to the present embodiment. Hereinafter, the process will be described with reference to the drawings.

S1: The score data generating unit 151 determines whether it is the timing for generating score data. An administrator provides a specified value, for example, a predetermined time a day as the timing for generating score data. The specified value can be provided several times a day or once several days. Alternatively, the specified value can be provided at the timing of the update of the store solution DB 120 and the Web solution DB 140.

S2: The score data generating unit 151 accesses the store solution DB 120 at the timing for generating score data to obtain the store operation result data of all the stores as far as possible. The store operation result data includes, for example, the reservation result data (FIG. 5), the coupon result data (FIG. 6), the sales result data (FIG. 7), and the customer history data (FIG. 7). Here, “to obtain the store operation result data of all the stores” means to obtain the store operation result data of all the stores that receive the store solution service. This is for generating the score data of all the stores. Here, the score data generating unit 151 obtains the store operation result data “as far as possible” because the store operation result data does not exist with respect to the store solution service that the store does not receive. Hence, the score data generating unit 151 does not obtain store operation result data which does not exist.

S3: The score data generating unit 151 subsequently accesses the Web solution DB 140 to obtain the Web management data of all the stores (FIG. 9). The score data generating unit 151 obtains the Web management data of all the stores in a similar manner to the store operation result data. However, the score data generating unit 151 does not obtain the Web management data of the store when the Web management data does not exist.

S4: The score data generating unit 151 generates the score data of each store using the obtained store operation result data and Web management data. As described above, the score data includes, for example, the “financial evaluation”, the “potentiality evaluation”, and the “evaluation on the Internet” (FIG. 10).

The “financial evaluation” is calculated mainly by specifying the store operation result data stored and accumulated in the store solution DB 120 as the input value and using a predetermined evaluation algorithm (for example, the predetermined evaluation function A). The score value of the “potentiality evaluation” is calculated mainly by specifying the store operation result data stored and accumulated in the store solution DB 120 as the input value and using a predetermined evaluation algorithm (for example, the predetermined evaluation function B). The score value of the “evaluation on the Internet” is calculated mainly by specifying the store Web manage data stored and accumulated in the Web solution DB 140 as the input value and using a predetermined evaluation algorithm (for example, the predetermined evaluation function C).

S5: The score data generating unit 151 generates the supplemental information of each store using the obtained store operation result data and Web management data. The supplemental information is transmitted together with the credit information to the loan determining terminal 310 in step S24 to be described below.

S6: The score data generating unit 151 associates the generated score data and supplemental information with each other, for example, corresponding to each store (each store ID) and then stores them in the storage unit 152. Note that the score data and supplemental information stored in the storage unit 152 can be written over the past score data and supplemental information on each update. The past score data and supplemental information can be stored for a certain period and deleted after the certain period has elapsed.

### Credit Information Generating Process

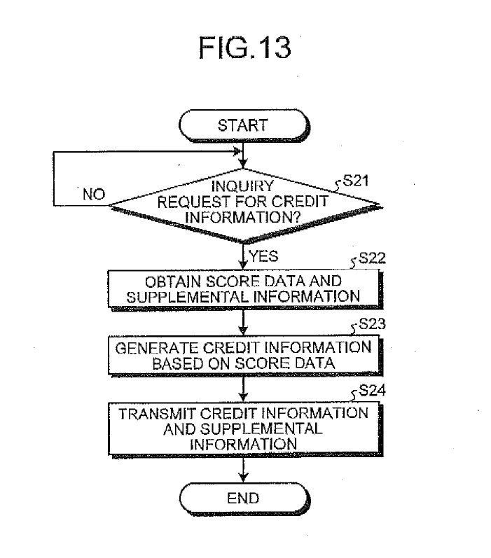

FIG. 13 is a flowchart of a process for generating credit information in the credit information generating server 150 according to the present embodiment.

S21: The credit information generating unit 153 determines whether an inquiry for the credit information (inquiry request) of the store 2 has been received from the loan determining terminal 310 of the financier 3. Note that the inquiry (inquiry request) for the credit information includes, for example, the store ID as the information for specifying the store 2 to be inquired.

S22: The credit information generating unit 153 obtains the score data and supplemental information of the stare to be inquired from the storage unit 152 using the store ID as a key.

S23: The credit information generating unit 153 generates the credit information based an the obtained score data (FIG. 11).

S24: Once generating the credit information, the credit information generating unit 153 transmits the generated credit information and the supplemental information obtained from the storage unit 152 to the loan determining terminal 310.

### Information Process in Loan Determining Terminal 310 Loan Condition Determining Process

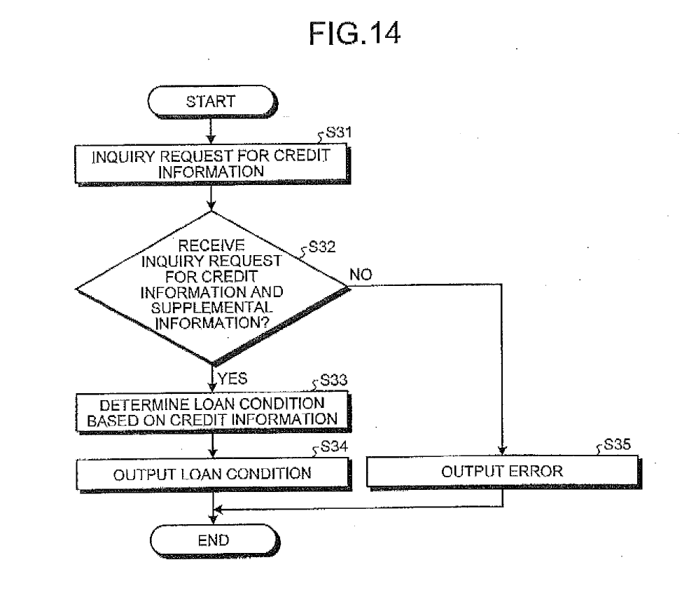

FIG. 14 is a flowchart of a process for determining loan condition by the loan determining terminal 310 according to the present embodiment.

S31: Once the financier 3 has input an inquiry operation and information designating the store to be inquired (for example, the store ID), the loan condition determining unit 312 transmits the inquiry (inquiry request) for the credit information to the credit information generating server 150.

S32: The credit information generating unit 153 determines in response to the inquiry (inquiry request) whether the inquiry (inquiry request) of the credit information and supplemental information about the store to be inquired has been received. Note that the credit information generating unit 153 outputs an error on a display screen or the like (S35) at least when not receiving the inquiry for a certain period.

S33: The loan condition determining unit 312 determines the loan condition to the store 2 based on the credit information of the store 2. The “loan condition” is determined based on the score data using a predetermined determination algorithm (fox example, a predetermined determination function E).

The score data according to the present embodiment includes the “financial evaluation”, the “potentiality evaluation”, and the “evaluation on the Internet”. Thus, the “loan condition” is calculated mainly by specifying the score data and a desired loan condition (a loan condition that the store desires) as the input values and using a predetermined determination algorithm.

S34: The loan condition determining unit 312 outputs the loan condition (credit limit) to the store 2 as the determination result on the display screen or the like.

### Exemplary Output Screen of Loan Condition

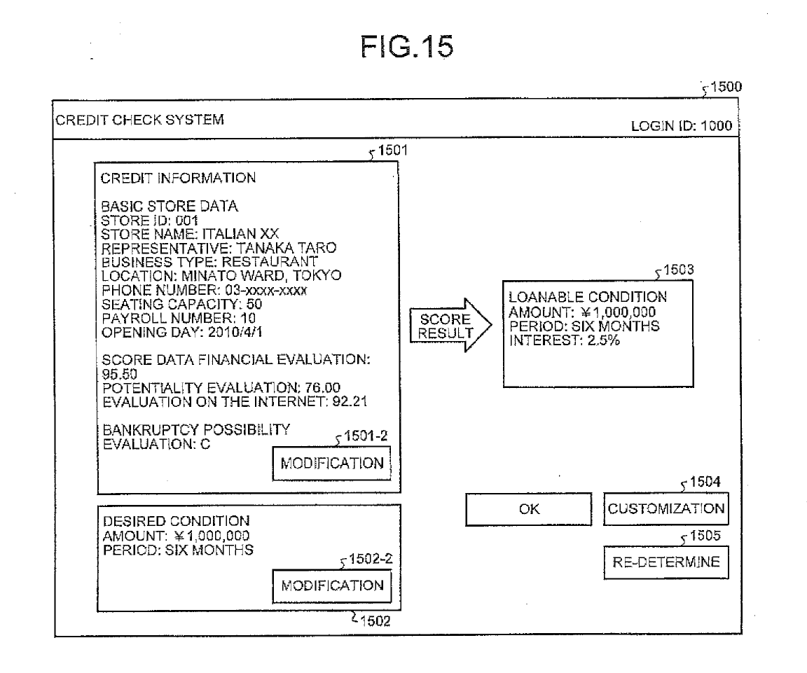

FIG. 15 is a diagram of an exemplary loan condition display screen in the loan determining terminal 310 according to the present embodiment. A screen 1500 includes a credit information section 1501, a desired condition section 1502, and a loanable condition section 1503.

The credit information section 1501 is a apace in which the credit information of the store received from the credit information generating server 150 is displayed. The financier 3 can modify the contents of the credit information using a “modification” 1501-2. Note that, basically, the contents of the credit information are not modified. The loan condition is determined according to the credit information. Thus, the financier 3 can modify the contents of the credit information of the store received from the credit information generating server 150 such that the financier 3 can determine the loan condition by taking the special circumstances of the financier 3 or the like into consideration.

The desired condition section 1502 is a space in, which the loan condition that the store desires is displayed. The desired condition is input by the financier 3. The financier 3 can modify the contents of the desired condition using a “modification” 1502-2. The financier 3 can simulate the determination of the loan condition based on the assumption of a provisional desired condition by provisionally changing the desired condition.

The loanable condition section 1503 is a space in which the loan condition determined based on the credit information of the store 2 is displayed. In other words, the determination result in step S33 is displayed. The financier 3 finally determines whether to actually provide a loan to the store with reference to the loan condition. The financier 3 also determines the specific conditions to provide a loan when providing the loan.

Note that, needless to say, the loan condition displayed in the loanable condition section 1503 is merely a criterion for final determination. The determination by the financier 3 is not necessarily bound by the loan condition. Thus, in addition to the loan condition displayed in the loanable condition section 1503, the financier 3 can separately determine the final loan condition with reference to the annual report of the store that the financier 3 has or other circumstances.

However, the loan condition displayed in the loanable condition section 1503 is determined using the score data based on the store operation result data and the Web management data as described above. In other words, the loan condition is not determined only based on an annual report or the like. Thus, the financier 3 preferably takes the loan condition displayed in the loanable condition section 1503 into consideration to some extent or more. This enables the financier 3 to introduce the latest, short-term, and many-aided evaluation to the final determination of the loan condition. Thus, the financier 3 can accurately determine the final loan condition.

The loan determining terminal 310 receives the supplemental information together with the score data. As described above, the supplemental information with which the score data is supplemented is in particular the RAW data (original data of the store operation result data and Web management data that the score data generating unit 151 has used for generating the score data. The loan determining terminal 310 may process the RAW data of the store operation result data and Web management data so that these pieces of information can be easily referred to on the loan determining terminal 310. The loan determining terminal 310 may display these pieces of information thereon without changes or with some processing. The financier 3 can use the store operation result data and the Web management data as a reference for determining the final loan condition.

As described below, the financier 3 can determine the loan condition repeatedly by pressing a “re-determine” 1505 after pressing a “customization” 1504 in the screen 1500 to perform a setting to be described below.

### Customization of Determination Parameter

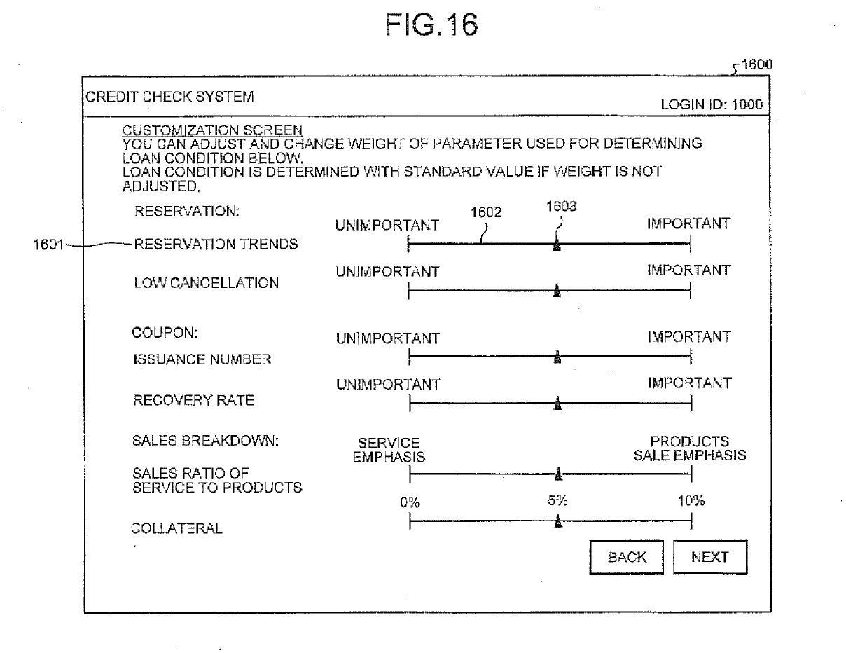

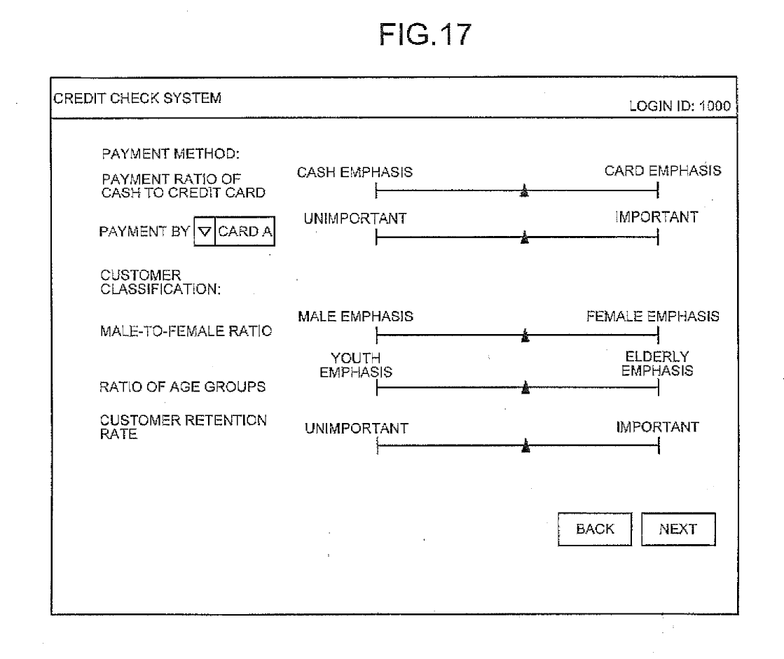

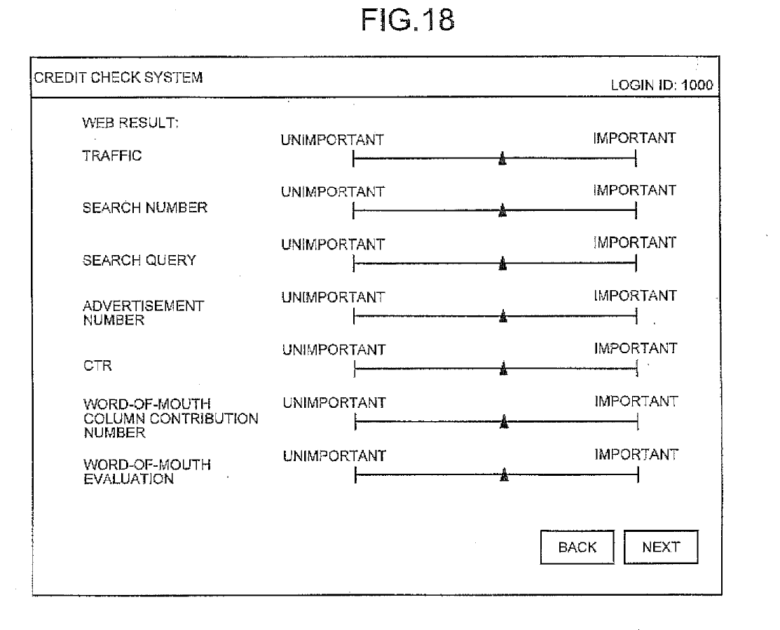

FIGS. 16 to 18 are diagrams of exemplary loan condition display screens in the loan determining terminal 310 according to the present embodiment. A screen 1600 includes a customization item 1601, an adjustment bar 1602, and an, adjustment knob 1603.

The customization item 1601 is a parameter item used for determining the loan condition. The adjustment bar 1602 is placed at each customization item 1601 to indicate the range of the adjustable weight values. The adjustment knob 1603 is a knob operated by a user to adjust the weight value to an applied value. The standard position of the knob indicating the standard value (default value) is placed at the center of the adjustment bar 1602.

The loanable condition is usually determined according to the received credit information. However, the financier 3 can take the special circumstances into consideration for the store by adjusting and changing the determination parameter. Adjusting the determination parameter means that the loan condition is determined with consideration of the adjusted and changed weight value of the parameter.

For example, when providing a loan to a store, the financier 3 sometimes wants to give a particular weight to the “reservation trends” than usual to provide the loan. In that case, the financier 3 moves the adjustment knob 1603 of a “reservation treads” 160 rightward. By moving the adjustment knob 1603 to the right, the financier 3 can increase the degree of importance of the “reservation trends” in determination of the loan condition.

On the other hand, when the financier 3 wants to give less importance to the “reservation trends” than usual to provide the loan, the financier 3 moves the adjustment knob 1603 of the “reservation trends” 160 leftward. By moving the adjustment knob 16703 to the left, the financier 3 can decrease the degree of importance of the “reservation trends” in determination of the loan condition.

In such a manner, the financier 3 can adjust the weights, for example, of the following determination parameters (FIGS. 16 to 18).

“Reservation”: “reservation trends” and “low cancellations”

“Coupon”: “issuance number” and “recovery rate”

“Sales breakdown”: “sales ratio of service to product” and “collateral”

“Payment method”: “payment ratio of cash to credit card” and “payment by card XX (card type selection)

“Customer classification”: “male-to-female ratio”, “ratio of age groups”, and “customer retention rate”

“Web result”: “access number”, “search number”, “search query”, “advertisement number”, “CTR”, “word-of-mouth column contribution number”, and “word-of-mouth evaluation”

After completing adjusting and changing the determination parameter, the financier 3 determines the loan condition again by pressing a “re-determine” 1505. Then, the recalculated credit information is displayed on the credit information section 1501 and the re-determined loan condition is displayed on the loanable condition section 1503.

Note that the “collateral” illustrated in FIG. 16 indicates the rate of collateral in the sales amount or in the card payment amount. The rate is incorporated as the collateral when the loan amount in the loan condition is determined. For example, when the “collateral” is 5% (standard) on a sales x (yen), x×1.05 (yen) is automatically incorporated (secured) as the collateral. This means that at least the amount of collateral is secured as the loan amount in the loan condition. In that case, for example, the loan amount in the loan condition is determined as an amount of at least x+1.05 (yen) or more.

### Operation of Determination Parameter

The loan condition determining unit 312 in the loan determining terminal 310 includes a predetermined algorithm as used for generating score data (for example, predetermined evaluation functions A, B, C, and D), similarly to the credit information generating server 150. Thus, when the determination parameter is adjusted and changed, the loan condition determining unit 312 firstly regenerates the score data and the supplemental information using the adjusted and changed determination parameter.

As described above, the supplemental information with which the score data is supplemented is in particular the RAW data (original data) of the store operation result data and Web management data that the score data generating unit 151 has used for generating the score data.

When the credit information generating server 150 generates the score data, the parameter indicated in the customization item 1601 has been taken into consideration. At that time, the degree of consideration of the parameter is the standard value placed at the center of the adjustment bar 1602.

The loan condition determining unit 312 regenerates the score data using the adjusted and changed determination parameter (and the supplemental information) when the determination parameter is adjusted and changed. In the regenerated score data, the adjusted and changed determination parameter is reflected.

The loan condition determining unit 312 modifies the portion corresponding to the score data in the credit information based on the regenerated score data. Note that the modified credit information is automatically reflected on the credit information section 1501 (FIG. 15). The modification is reflected in a similar manner when the financier 3 manually modifies the contents of the credit information using the “modification” 1501-2.

When the financier 3 presses the “re-determine” 1505, the loan condition determining unit 312 determines the loan condition (credit limit) to the store 2 based on the modified credit information of the store 2. Note that the “loan condition” is determined based on the modified score data and using a predetermined determination algorithm (for example, the predetermined determination function 5). In other words, the loan condition is determined in consideration of the adjusted and changed determination parameter.

For example, when the importance of the “reservation trends” has been increased using the adjustment knob 1603 of the “reservation trends” 160, the score value of the “potentiality evaluation” of a store of which the reservation trends has steadily been upward in the reservation result data (FIG. 5) becomes high in the score data (1505 in FIG. 15). This is caused by the increase in the value of the weight coefficient of the “reservation trends” in a predetermined evaluation algorithm for calculating the score value of the “potentiality evaluation” (for example, a predetermined evaluation function B). As a result, more favorable condition can be determined than before the adjustment and change of the determination parameter (1503 in FIG. 15). Specifically, the loan amount is increased, the loan period is extended, or the loan interest is reduced.

Note that, as a variation of the embodiment, the loan condition can be determined by reflecting the adjusted and changed determination parameter without using the supplemental information. In that case, the loan condition determining unit 312 directly modifies the determined loan condition using the adjusted and changed determination parameter when the determination parameter is adjusted and changed.

For example, when the importance of the “reservation trends” has been increased using the adjustment knob 1603 of the “reservation trends” 160, a certain amount can be added to the loan amount, a certain period can be added to the loan period, or the loan interest may be decreased by a certain rate in the loan condition.

As described above, according to the present embodiment, the loan condition is determined based on the store operation result data and Web management data accumulated and updated in real time, unlike a technology in which the loan condition is determined only based on an annual report or the like. Hence, the financier 3 can take into consideration the latest, short-term, many-sided evaluations in the determination of the final loan condition. Thus, the financier 3 can more accurately determine the final loan condition.

In the above, the provider 1 and the financier 3 are described as separate entities. However, the provider 1 and the financier 3 may be a single entity. The present invention can be applied to such an entity. For example, the provider 1 may be a store solution provider also acting as the financier 3. The provider 1 receives a loan application from the store 2 to which the store solution service is provided, determines the loan condition, and actually provides a loan to the store 2.

An embodiment of the present invention enables an evaluation of an entity based on a latest, short-term, and many-sided evaluation axis and an accurate calculation of a loan, condition for the entity.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A loan system comprising:
a loan determining device configured to determine a loan condition; and
a credit information generating device configured to provide credit information of a store, which applies for a loan, to the loan determining device, the credit information generating device including
a storage unit that stores store operation result data including accumulation of latest data generated along with a store operation;
a score data generating unit configured to generate score data of the store based on the store operation result data in a predetermined period; and
a credit information generating unit configured to generate credit information of the store based on the score data, and
the loan determining device including
a credit information obtaining unit configured to obtain the credit information of the store; and
a loan condition determining unit configured to determine a loan condition to the store based on the credit information of the store.

2. The loan system according to claim 1,
wherein the store operation result data includes at least one of reservation result data and coupon issuance result data, and
the score data generating unit generates the score data of future potential of the store based on the store operation result data in a predetermined period.

3. The loan system according to claim 2,
wherein the store operation result data includes at least one of reservation result data, the coupon issuance result data, sales breakdown data, payment method breakdown data, payment card type data, and customer data, and
the loan condition determining unit repeats determination of the loan condition based on a weight value given to the store operation result data.

4. The loan system according to claim 3,
wherein the store operation result data includes at least one of sales amount data and card payment amount data, and
the loan condition determining unit secures at least one of an amount of a predetermined rate of sales amount indicated in the sales amount data and an amount of a predetermined rate of a card payment amount indicated in the card payment amount data as a loan amount in the loan condition.

5. The loan system according to claim 1,
wherein the storage unit stores Web management data of the store, and
the score data generating unit generates the score data of the store based on the Web management data in a predetermined period.

6. The loan system according to claim 5,
wherein the Web management data includes at least one of traffic to a Website of the store, a search number, a search query, an advertisement number, a CTR of the advertisement, a word-of-mouth column contribution number, and a word-of-mouth evaluation of the store, and
the score data generating unit generates the score data on the future potential of the store based on the Web management data in a predetermined period.

7. The loan system according to claim 6,
wherein the loan condition determining unit repeats determination of the loan condition based on a weight value given to the Web management data.

8. A loan condition determining method in a loan system including a loan determining device configured to determine a loan condition, and a credit information generating device configured to provide credit information of a store, which applies for a loan, to the loan determining device, the loan condition determining method comprising:
storing, by the credit information generating device, store operation result data including accumulation of latest data generated along with a store operation;
generating, by the credit information generating device, score data of the store based on the store operation result data in a predetermined period; and
generating, by the credit information generating device, credit information of the store based on the score data, and
obtaining, by the loan determining device, the credit information of the store; and
determining, by the loan determining device, a loan condition to the store based on the credit information of the store.

9. A computer-readable recording medium having stored therein a loan condition determining program executed by a computer for a loan system including a loan determining device configured to determine a loan condition, and a credit information generating device configured to provide credit information of a store, which applies for a loan, to the loan determining device, the program causing a computer to execute a process comprising:
storing store operation result data including accumulation of latest data generated along with a store operation;
generating score data of the store based on the store operation result data in a predetermined period;
generating credit information of the store based on the score data;
obtaining the credit information of the store; and
determining a loan condition to the store based on the credit information of the store.

10. A credit information generating device configured to provide credit information of a store, which applies for a loan, to a loan determining device configured to determine a loan condition, the credit information generating device comprising:
a storage unit that stores store operation result data including accumulation of latest data generated along with a store operation;
a score data generating unit configured to generate score data of the store based on the store operation result data in a predetermined period; and
a credit information generating unit configured to generate credit information of the store based on the score data.

11. A loan determining device configured to determine a loan condition for a store, which applies for a loan, the loan determining device comprising:
a credit information obtaining unit configured to obtain credit information of the store generated by a credit information generating device based on store operation result data in a predetermined period; and
a loan condition determining unit configured to determine a loan condition to the store based on the credit information.

12. A computer-readable recording medium having stored therein a credit information generating program, the program causing a computer to function as:
a storage unit that stores store operation result data including accumulation of latest data generated along with a store operation;
a score data generating unit configured to generate score data of the store based on the store operation result data in a predetermined period; and
a credit information generating unit configured to generate credit information of the store based on the score data.

13. A computer-readable recording medium having stored therein a loan condition determining program, the program causing a computer to function as:
a credit information obtaining unit configured to obtain credit information of the store generated by a credit information generating device and based on store operation result data in a predetermined period; and
a loan condition determining unit configured to determine a loan condition to the store based on the credit information.
